(19) United States
(12) Patent Application Publication
(10) Pub. No.: US 2022/0192370 A1
(43) Pub. Date: Jun. 23, 2022

(54) SYSTEMS, METHODS, AND DEVICES FOR A STAND

(71) Applicant: Monti Kids, Inc., Orinda, CA (US)

(72) Inventor: Yuki Kawae, Oakland, CA (US)

(21) Appl. No.: 17/555,246

(22) Filed: Dec. 17, 2021

Related U.S. Application Data
(60) Provisional application No. 63/127,979, filed on Dec. 18, 2020.

(51) Int. Cl. A47B 47/00; F16B 5/00

(52) U.S. Cl. CPC A47B 47/0075; F16B 5/002

(57) ABSTRACT

Some embodiments relate to a stand that complies with safety standards. The stand includes a first shelf, wherein the first shelf comprises two first elongated slots and two first holes located in the vicinity of each end of the first shelf. The stand also includes a second shelf. Additionally, the stand includes a first wall, wherein the first wall comprises two third elongated slots and a first notch, wherein the two third elongated slots are sized to slide and fit into one of the first elongated slots and one of the second elongated slots respectively. The stand also includes a second wall. Additionally, the stand includes two connecting bars each is sized to fit into one of the two first holes and one of the two second holes respectively, the two connecting bars each further comprises a flange sized to fit into the first notch and the second notch respectively.

### CLAIM OF PRIORITY UNDER 35 U.S.C. § 119

The present application claims priority to U.S. Provisional Patent Application No. 63/127,979, entitled “STAND,” filed Dec. 18, 2020, and assigned to the assignee hereof and hereby expressly incorporated by reference herein.

### TECHNICAL FIELD

Embodiments of the present disclosure generally relate to stands and racks, and more specifically to a stand that complies with educational methods, such as the Montessori method.

### BACKGROUND OF THE INVENTION

Montessori materials may be created to promote independence and autonomy in small children and toddlers. People with certain disabilities may also benefit from these materials. Small children and toddlers may use the Montessori materials which may promote independence and autonomy as the small children learn to care for themselves. Stands, racks, or a combination of both stands and racks may be used to store the Montessori materials.

School materials, and Montessori school materials in particular, need to be safe for children to use. The school materials, e.g., Montessori school materials are usually designed after multiple experimentations (including experiments to determine weight, size, and shape of both the finished products as well as the individual components of the finished products) in order to comply with both the Montessori educational method and also comply with the safety requirements as provided by various agencies such as the Consumer Product Safety Commission (CPSC), American Society for Testing and Materials (ASTM), other foreign agencies providing safety requirements, or other agencies that provide safety requirements. The materials are usually made of wood. However, there is a lack of stands and racks that comply with the safety requirements so the stands and racks can be used in a Montessori school environment.

Accordingly, it may be advantageous to have stands and racks that may comply with the safety requirements in place at the time of manufacture, as provided by one or more of the various agencies.

### SUMMARY OF THE INVENTION

Provided herein are embodiments of a stand or rack that may comply with educational methods, including the Montessori method. The stand or rack may also comply with the safety requirements in place at the time of manufacture, as provided by one or more of the various agencies such as CPSC, ASTM, other foreign agencies, or other agencies that provide safety requirements.

Some embodiments relate to a stand that complies with safety standards. In one example embodiment, the stand includes a first shelf, wherein the first shelf comprises two first elongated slots and two first holes located in the vicinity of each end of the first shelf. The stand also includes a second shelf, wherein the second shelf comprises two second elongated slots and two second holes located in the vicinity of each end of the second shelf. Additionally, the stand includes a first wall, wherein the first wall comprises two third elongated slots and a first notch, wherein the two third elongated slots are sized to slide and fit into one of the first elongated slots and one of the second elongated slots respectively. The stand also includes a second wall, wherein the second wall comprises two fourth elongated slots and a second notch, wherein the two fourth elongated slots are sized to slide and fit into one of the first elongated slots and one of the second elongated slots respectively. Additionally, the stand includes two connecting bars each is sized to fit into one of the two first holes and one of the two second holes respectively, the two connecting bars each further comprises a flange sized to fit into the first notch and the second notch respectively.

Some embodiments relate to a stand that complies with safety standards. In one example embodiment, the stand includes stand includes at least one shelf that comprises at least one first elongated slot and at least one first hole located in the vicinity of an end of the shelf. The stand also includes at least one side wall that comprises at least one second elongated slot and a notch, the notch located on a top side of the side wall. Additionally, the stand includes at least one connecting bar that comprises a flange at one end of the connecting bar, wherein the at least one first elongated slot and the at least one second elongated slot are sized to slide and fit into each other, and wherein the at least one connecting bar is sized to fit through the at least one first hole, and wherein the flange is sized to fit into the notch.

Some embodiments relate to a method of a stand. The method includes providing a stand in a flat shipping configuration that complies with safety standards. The stand includes a first shelf, wherein the first shelf comprises two first elongated slots and two first holes located in proximally to each end of the first shelf, a second shelf, wherein the second shelf comprises two second elongated slots and two second holes located in the proximally to each end of the second shelf, a first wall, wherein the first wall comprises two third elongated slots and a first notch, wherein the two third elongated slots are sized to slide and fit into one of the first elongated slots and one of the second elongated slots respectively, a second wall, wherein the second wall comprises two fourth elongated slots and a second notch, wherein the two fourth elongated slots are sized to slide and fit into one of the first elongated slots and one of the second elongated slots respectively, and two connecting bars, each sized to fit into one of the two first holes and one of the two second holes respectively, the two connecting bars each further comprising a flange sized to fit into the first notch and the second notch respectively. The method further includes assembling the stand, including sliding each of the two fourth elongated slots into one of the first elongated slots and one the second elongated slots respectively and fitting at least one flange of the two connecting bars into at least one of the first notch and the second notch.

This summary and the following detailed description are merely exemplary, illustrative, and explanatory, and are not intended to limit, but to provide further explanation of the invention as claimed. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 illustrates an exploded view of an exemplary stand or rack, according to some embodiments of the present disclosure.

FIG. 2 illustrates another exploded view of an exemplary stand or rack with some directions for assembly, according to some embodiments of the present disclosure.

FIG. 3 illustrates another exploded view of an exemplary stand or rack, according to some embodiments of the present disclosure.

FIG. 4 illustrates a view of an exemplary stand or rack partially assembled, with some directions for assembly, according to some embodiments of the present disclosure.

FIG. 5 illustrates a view of an exemplary stand or rack fully assembled, according to some embodiments of the present disclosure.

FIG. 6 is a flow diagram illustrating a method in accordance with the systems and methods described herein.

### DETAILED DESCRIPTION

The following disclosure describes various embodiments of the present invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is illustrated in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated.

Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As described below, various dimensions have been specified in exemplary embodiments. This disclosure is not limited to such dimensions and any dimensions that may still ensure educational and safety compliance as described herein may be used for the various components of the various embodiments described herein. Further, various components are not limited to the shapes, sizes, colors, and/or materials as described herein. Any shapes, sizes, colors, and/or materials that may still ensure educational and safety compliance as described herein may be used for the various components of the various embodiments described herein. Further, although the stand of the present disclosure may be tight-fit assembled without using any additional attachment mechanism, in some alternative embodiments, any attachment mechanism, such as glue, zippers, buttons, snaps, nails, hooks, or other appropriate attachment mechanisms, may be used to secure the components of each embodiment. Finally, various surfaces, sides, and features of various components of the embodiments described herein are per how a person skilled in the art would construe those characteristics unless otherwise specified.

The designs disclosed herein require in-depth knowledge of 0-3-year-old safety testing requirements (in multiple countries) and expert understanding of both educational curriculums, including the Montessori curriculum, and concepts of 0-3-year-old material design to create.

The present disclosure describes various embodiments of a stand that complies with educational methods, e.g., including the Montessori method, and may also comply with the safety requirements as provided by various agencies such as CPSC, ASTM, other foreign agencies, or other safety agencies.

In an example embodiment, the style of the shelf may be in compliance with the Montessori method because the shelf may allow unencumbered access to toys on the shelf by the child, at the perfect height, so the child may independently access and put back any of the toys. Independent play and self-driven learning are elements of the Montessori program, and as such, providing a stable, accessible, uncluttered, appealing display of materials support that. Also, in an example embodiment, the shelf does not include any distracting, frilly elements that might take the child's focus away from the more important educational materials being stored on the shelf. Also, the protruding parts on the top of the shelf may allow a toddler to practice pulling up to a standing position.

From a safety perspective, the shelf may be uniquely assembled without any hardware or fastenings or removable components that could become detached and form a small part hazard (e.g., choking hazard), which is very rare for furniture. The stand does not contain sharp points, and the design may minimize the risk of unexpected hazards that can be caused by tipping or overloading. In addition, the stand is tested for and meets current ASTM and CPSC requirements. In an example embodiment, the stand can hold over 100 pounds of weight simultaneously on each shelf. In an example embodiment, the coating and wood substrate are safe from harmful substances, including lead and phthalates. In an example embodiment, other benefits include, but are not limited to that the stand may be disassembled and laid completely flat for storage or shipping and no tools are required for assembly.

In an example embodiment, the low shelf design of the present disclosure with a wide base allows for not only a piece of furniture for storage but also an apparatus for a young baby to pull up on and use for gross motor development. While the low shelf design may be used for storage and accessibility, this added feature, e.g., after passing safety, also allows for the low shelf to have other purposes. The low shelf is also unique in the low shelf's design for set up as the low shelf may not require hardware or tools to assemble. The low profile with the top shelf being within easy reach of a toddler and the low shelf being nearly on the ground to allow for infant access to the low shelf provides for Montessori style.

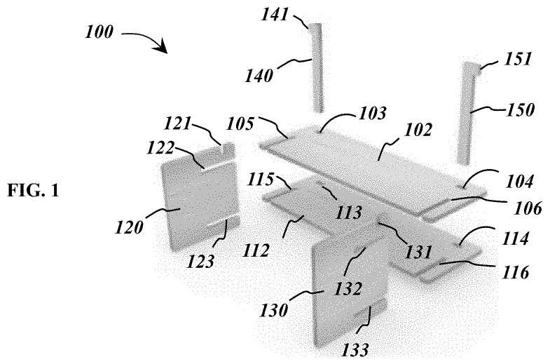

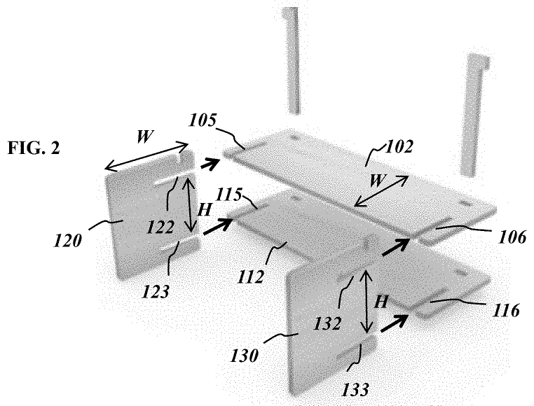

Referring to FIG. 1, an exploded view of an exemplary stand 100 of the present disclosure, according to some embodiments, is illustrated. In this example, the stand 100 may include two platforms (e.g., shelves 102 and 112), two side walls 120 and 130, and two connecting bars 140 and 150 (which may also be referred to as poles, keys, rectangle stoppers, or stoppers). In some embodiments, the shelves 102 and 112 may have a rectangular shape. The horizontal shelves 102 and 112, and the walls 120 and 130 may have the same width W, e.g., as illustrated in FIG. 2.

In some embodiments, the horizontal shelf 102 may include two elongated apertures (slots) 105 and 106 and two apertures (holes) 103 and 104 located toward the two ends of the horizontal shelf 102. The wall 120 may include two elongated apertures (slots) 122 and 123, and an aperture (e.g., notch 121 or indentation). As illustrated further in FIGS. 2, 3 and 4, the two elongated slots 122 and 123 may have the same size (width and length) as the two elongated slots 105 and 106, so that the two elongated slots 105 and 106 may slide and fit into the two elongated slots 122 and 123.

The horizontal shelf 112 may be made like the horizontal shelf 102. As such, the horizontal shelf 112 may also include two elongated apertures (slots) 115 and 116 and two apertures (holes) 113 and 114 located toward the two ends of the horizontal shelf 112.

The wall 130 may be made like the wall 120. As such, the wall 120 may also include two elongated apertures (slots) 132 and 133, and an aperture (e.g., notch 131 or indentation).

As illustrated further in FIGS. 2, 3, and 4, the two elongated slots 132 and 133 may have the same size (width and length) as the two elongated slots 115 and 116, so that the two elongated slots 115 and 116 may slide and fit into the two elongated slots 132 and 133.

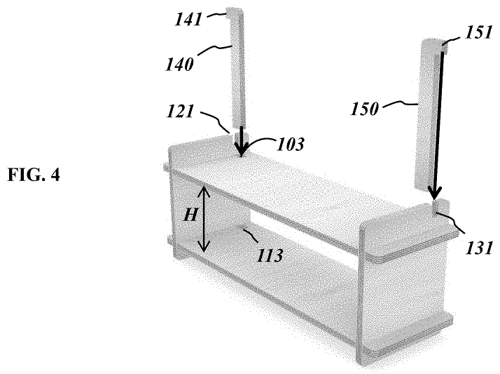

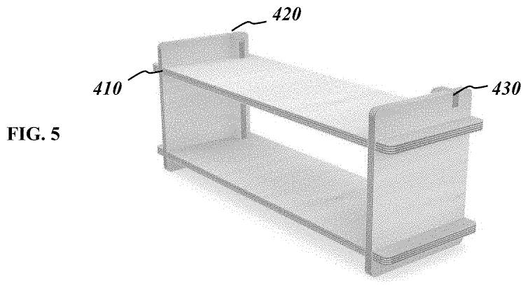

In the illustrated example of FIG. 1, the various pieces are positioned such that the elongated slot 105 may slide into the elongated slot 122. The elongated slot 115 may slide into the elongated slot 123. The elongated slot 106 may slide into the elongated slot 132. The elongated slot 116 may slide into the elongated slot 133. With the elongated slot 105 slid into the elongated slot 122, the elongated slot 115 slid into the elongated slot 123, the elongated slot 106 slid into the elongated slot 132, and the elongated slot 116 slid into the elongated slot 133, the stand 100 may be formed (see FIGS. 4-5).

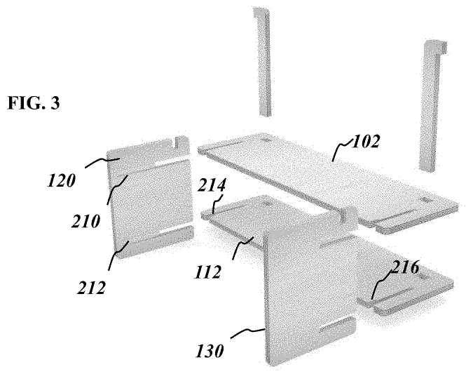

FIG. 3 illustrates another view of the stand. As illustrated, in some embodiments, the slots 122, 123, 132 and 133 may each include a shallow groove (e.g., grooves 210 and 212 as illustrated). In some embodiments, the slots 105, 106, 115 and 116 may each include a notch (e.g., notches 214 and 216 as illustrated) where the corresponding shallow groove of a wall may end. For example, when the wall 120 is assembled with shelves 102 and 112, the shallow groove may end at the notch 214. In some embodiments, the grooves add additional stabilization. These shallow grooves will hold up the shelf all the way close to the edge of the shelf, making a much more stable structure.

As illustrated further in FIGS. 4 and 5, the holes 103, 104, 113 and 114 may have the same size as the two connecting bars 140 and 150 (or poles), so that the two connecting bars 140 and 150 may fit into the holes 103, 104, 113 and 114.

In some embodiments, the connecting bars 140 and 150 may each include a projecting element (flange) 141 and 151, respectively, at a top end. The flanges 141 and 151 are sized to fit into the notches 121 and 131 respectively. As illustrated further in FIGS. 4 and 5, the two connecting bars 140 and 150 may be inserted through the two holes 103 and 104, then into the two holes 113 and 114.

The length of the connecting bars 140 and 150 may be made so that when the flanges 141 and 151 rest and fit into the notches 121 and 131 respectively, the bars 140 and 150 fit through the two holes 103 and 104, then into the two holes 113 and 114 such that the bottom end of each of the bars 140 and 150 may be flush with the bottom surface of the shelf 112.

FIG. 5 illustrates the stand 100 when fully assembled. As illustrated in FIG. 5, the flanges 141 and 151 may have the same height with the notches 121 and 131, so that when the flanges 141 and 151 rest and fit into the notches 121 and 131, the top of the flanges 141 and 151 may be flush with the top of the walls 120 and 130.

As illustrated, the height H, of the stand 100 may be determined by the distance H between the slots 122 and 123 (and between the slots 132 and 133). The length of the connecting bars 140 and 150 is also a function of the height H.

In one example embodiment, when the stand 100 is fully assembled, all components may be flush to provide smooth edges.

In some embodiments, the stand may be assembled using only tight fitting of all parts. For example, in some embodiments no screws, nails, or other fasteners are used. Rather, friction between the tight-fitting parts may hold the assembly together.

In some alternative embodiments, glue may be used in assembling the stand. For example, in some embodiments glue (or glues) may be used in conjunction with the friction of the tight-fitting parts.

Although the example above illustrates a stand with two shelves, the stand of the present disclosure may include more than two shelves. When the stand has more than two shelves, the side walls may have corresponding height. Additionally, when the stand has more than two shelves, e.g., one additional shelf, the number of elongated slots may be increased. For example, two additional elongated slots (e.g., in the side walls) may be used per shelf. Additionally, when the stand has more than two shelves two additional elongated slots (e.g., in the shelf) may be used per shelf. Additional sidewalls with slots may be used to provide additional stability in the shelves. In other words, additional walls, e.g., at the center of the shelf, may improve stability.

Although the example above illustrates a stand having rectangular shelves, the stand of the present disclosure may have shelves in other shapes, for example, square shelves, oval shelves, or any other appropriate shelf shape.

In some embodiments, the stand may be made of wood. In other embodiments, other materials may be used to build the fan.

In some embodiments, the stand may not require hardware to put together. In some embodiments, the stand may be made of wood. In some embodiments, the stand may require hardware to put the stand together.

In some example applications, the stand may be configured to store items. In other example applications, the stand may be used to display items.

As used herein, components, parts and pieces may be used interchangeably.

In some embodiments, the stand may be stored and shipped flat. For example, the stand 100 may be shipped disassembled or partially disassembled such that the pieces may be shipped.

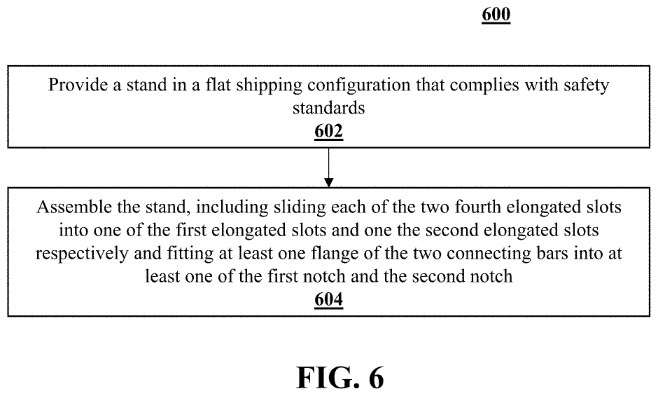

FIG. 6 is a flow diagram illustrating a method in accordance with the systems and methods described herein. The method includes providing a stand in a flat shipping configuration that complies with safety standards (602). The stand includes a first shelf, wherein the first shelf comprises two first elongated slots and two first holes located in proximally to each end of the first shelf, a second shelf, wherein the second shelf comprises two second elongated slots and two second holes located in the proximally to each end of the second shelf, a first wall, wherein the first wall comprises two third elongated slots and a first notch, wherein the two third elongated slots are sized to slide and fit into one of the first elongated slots and one of the second elongated slots respectively, a second wall, wherein the second wall comprises two fourth elongated slots and a second notch, wherein the two fourth elongated slots are sized to slide and fit into one of the first elongated slots and one of the second elongated slots respectively, and two connecting bars, each sized to fit into one of the two first holes and one of the two second holes respectively, the two connecting bars each further comprising a flange sized to fit into the first notch and the second notch respectively. The method also includes assembling the stand, including sliding each of the two fourth elongated slots into one of the first elongated slots and one the second elongated slots respectively and fitting at least one flange of the two connecting bars into at least one of the first notch and the second notch (604).

In an aspect of the method, at least one side wall further includes at least one shallow groove.

In an aspect of the method, at least two components come together flush to provide a smooth edge.

In an aspect of the method, at least two components are held together using a friction fit.

In an aspect of the method, wherein at least two components are held together using glue in conjunction with a friction fit.

In an aspect of the method, wherein the stand is made of wood.

In an aspect of the method, wherein components of the stand are configured to ship flat.

1. A stand that complies with safety standards, comprising:
a first shelf, wherein the first shelf comprises two first elongated slots and two first holes located in proximally to each end of the first shelf;
a second shelf, wherein the second shelf comprises two second elongated slots and two second holes located in the proximally to each end of the second shelf;
a first wall, wherein the first wall comprises two third elongated slots and a first notch, wherein the two third elongated slots are sized to slide and fit into one of the first elongated slots and one of the second elongated slots respectively;
a second wall, wherein the second wall comprises two fourth elongated slots and a second notch, wherein the two fourth elongated slots are sized to slide and fit into one of the first elongated slots and one of the second elongated slots respectively; and
two connecting bars, each sized to fit into one of the two first holes and one of the two second holes respectively, the two connecting bars each further comprising a flange sized to fit into the first notch and the second notch respectively.

2. The stand of claim 1, wherein at least two components come together flush to provide a smooth edge.

3. The stand of claim 1, wherein at least two components are held together using a friction fit.

4. The stand of claim 1, wherein at least two components are held together using glue in conjunction with a friction fit.

5. The stand of claim 1, wherein the stand is made of wood.

6. The stand of claim 1, wherein components of the stand are configured to ship flat.

7. A stand that complies with safety standards, comprising:
at least one shelf that comprises at least one first elongated slot and at least one first hole located in proximally to an end of the shelf;
at least one side wall that comprises at least one second elongated slot and a notch, the notch located on a top side of the side wall;
at least one connecting bar that comprises a flange at one end of the connecting bar;
and wherein the at least one first elongated slot and the at least one second elongated slot are sized to slide and fit into each other, and wherein the at least one connecting bar is sized to fit through the at least one first hole, and wherein the flange is sized to fit into the notch.

8. The stand of claim 7, wherein at least two components come together flush to provide a smooth edge.

9. The stand of claim 7, wherein at least two components are held together using a friction fit.

10. The stand of claim 7, wherein at least two components are held together using glue in conjunction with a friction fit.

11. The stand of claim 7, wherein the stand is made of wood.

12. The stand of claim 7, wherein components of the stand are configured to ship flat.

13. A method comprising:
providing a stand in a flat shipping configuration that complies with safety standards, the stand comprising:
a first shelf, wherein the first shelf comprises two first elongated slots and two first holes located in proximally to each end of the first shelf,
a second shelf, wherein the second shelf comprises two second elongated slots and two second holes located in the proximally to each end of the second shelf,
a first wall, wherein the first wall comprises two third elongated slots and a first notch, wherein the two third elongated slots are sized to slide and fit into one of the first elongated slots and one of the second elongated slots respectively,
a second wall, wherein the second wall comprises two fourth elongated slots and a second notch, wherein the two fourth elongated slots are sized to slide and fit into one of the first elongated slots and one of the second elongated slots respectively, and
two connecting bars, each sized to fit into one of the two first holes and one of the two second holes respectively, the two connecting bars each further comprising a flange sized to fit into the first notch and the second notch respectively; and
assembling the stand, including sliding each of the two fourth elongated slots into one of the first elongated slots and one the second elongated slots respectively and fitting at least one flange of the two connecting bars into at least one of the first notch and the second notch.

14. The method of claim 13, wherein at least two components come together flush to provide a smooth edge.

15. The method of claim 13, wherein at least two components are held together using a friction fit.

16. The method of claim 13, wherein at least two components are held together using glue in conjunction with a friction fit.

17. The method of claim 13, wherein the stand is made of wood.
